(19) United States
(12) Patent Application Publication
(10) Pub. No.: US 2020/0097966 A1
(43) Pub. Date: Mar. 26, 2020

(54) INFORMATION PROCESSING METHOD, INFORMATION PROCESSING DEVICE, AND COMPUTER-READABLE NON-TRANSITORY STORAGE MEDIUM STORING PROGRAM

(71) Applicant: Mercari, Inc., Tokyo (JP)

(72) Inventor: Keita NAKAMURA, Tokyo (JP)

(21) Appl. No.: 16/581,916

(22) Filed: Sep. 25, 2019

(30) Foreign Application Priority Data
Sep. 25, 2018 (JP) 2018-178241

(51) Int. Cl. G06Q 20/40; G06Q 20/22; G06Q 20/42

(52) U.S. Cl. CPC G06Q 20/405; G06Q 20/42; G06Q 20/227

(57) ABSTRACT

According to the present disclosure, there is provided a computer-readable non-transitory storage medium storing a program for causing one or a plurality of processors of an information processing device to execute deposit processing for, when receiving transaction information for depositing a consideration of goods or services and a guarantee charge into a first account, transmitting, on the basis of the received transaction information, information concerning the transaction information to a second account that receives the consideration and settlement processing for, after performing the deposit processing, when receiving, from a third account which deposits the consideration, a result notification to the effect that the goods or the services are received, transferring the consideration from the first account to the second account and transferring the guarantee charge from the first account to a fourth account.

### BACKGROUND OF THE INVENTION

### Field of the Invention

The present disclosure relates to an information processing method, an information processing device, and a computer-readable non-transitory storage medium storing a program.

### Description of the Related Art

Services that enable users to perform sales transactions through a network using terminals such as a computer, a smartphone, a tablet, and a cellular phone having a communication function have been widely used in general. In such services, a mechanism for securing security of a transaction is used by conditionally settling a consideration of goods with a third party mediating between a seller and a purchaser. For example, a mechanism is used in which the purchaser applies for purchase of goods from a site operated by a service provider and deposits a consideration of the goods with the service provider, the service provider with which the consideration is deposited informs the seller to that effect, the seller sends the goods, and, when being informed by the purchaser that the purchaser receives the goods, the service provider pays the deposited consideration to the seller. Such a mechanism is called escrow as well. The third party that mediates the transaction in the escrow is called escrow operator as well.

However, the mechanism of the escrow is based on the premise that the escrow operator is bona fides. If the escrow operator acts wrong, it is likely that the purchaser or the seller suffers a loss, for example, a deposited consideration of goods is stolen.

Incidentally, recently, a blockchain technique that can construct a transaction system with high credibility has been attracting attention in that falsification of transaction information is practically impossible and impersonation is also impossible in a transaction. By combining the blockchain technique and a smart contract technique for programming a series of processing, which has been performed by a service provider in the past, and automatically executing the series of processing, it is possible to construct a transaction system with high credibility not via human operation.

Japanese Patent No. 6224283 (Patent Literature 1) describes an information processing method for performing, in a sales transaction of goods via a network, a transaction guaranteeing security and reliability by constructing and executing a series of processing in escrow settlement using a smart contract without using a virtual currency.

As explained above, the mechanism of the escrow is a mechanism for performing mediation of a transaction based on the premise that the escrow operator is bona fides. The mechanism of the escrow is not a mechanism for preventing the escrow operator from acting wrong. If it is assumed that a sales transaction of goods between users not via a specific administrator expands according to the infiltration of the blockchain technique, market entry of various escrow operators that mediate the transaction is expected. Based on such an assumption, there is a demand for a mechanism that can prevent illegal escrow operators from entering the market even when a sales transaction is performed not via the specific administrator and enables a transaction with security and reliability guaranteed.

Patent Literature 1 describes an information processing method in which mainly a financial institution server receives payment processing of goods from a purchaser, determines possibility of payment of a consideration of the goods on the basis of account information and the like of the purchaser, and executes settlement processing when determining that the payment is possible. In this information processing method, a series of processing for performing payment on condition that it is determined that the payment is possible is realized by a smart contract. However, Patent Literature 1 does not describe a technique that can prevent entry of illegal escrow operators and enables a transaction with security and reliability guaranteed even when a sales transaction is performed not via a specific administrator.

### SUMMARY OF THE INVENTION

Therefore, the present disclosure has been devised in view of such circumstances, and an object of the present disclosure is to provide an information processing method, an information processing device, and a computer-readable non-transitory storage medium storing a program for smoothly achieving a transaction with security and reliability guaranteed even when the transaction is performed not via a specific administrator.

A program stored in a computer-readable non-transitory storage medium according to an embodiment of the present disclosure causes one or a plurality of processors included in an information processing device to execute: deposit processing for, when receiving transaction information for depositing a consideration of goods or services and a guarantee charge into a first account, transmitting, on the basis of the received transaction information, information concerning the transaction information to a second account that receives the consideration; and settlement processing for, after performing the deposit processing, when receiving, from a third account which deposits the consideration, a result notification to the effect that the goods or the services are received, transferring the consideration from the first account to the second account and transferring the guarantee charge from the first account to a fourth account.

### BRIEF DESCRIPTION OF THE DRAWINGS

FIG. 1 shows the configuration of a communication system according to an aspect of an embodiment;

FIG. 2 shows an example of a hardware configuration of an information processing device according to the present disclosure;

FIG. 3 shows an example of a block diagram showing the configuration of a first information processing device according to a first embodiment;

FIG. 4 shows a part of a data structure stored by a BC information DB;

FIG. 5 shows an example of a block diagram showing the configuration of a second information processing device according to the first embodiment;

FIG. 6 shows an example of a block diagram showing the configuration of a third information processing device according to the first embodiment;

FIG. 7 shows an example of a block diagram showing the configuration of a fourth information processing device according to the first embodiment;

FIG. 8 shows an example of a sequence chart showing processing performed by a communication system in the first embodiment;

FIG. 9 shows an example of a flowchart of processing in a server in the first embodiment;

FIG. 10 shows an example of a sequence chart showing an operation example of an information processing system in a first example; and

FIG. 11 shows an example of a sequence chart showing an operation example of an information processing system in a second example.

### DETAILED DESCRIPTION OF THE PREFERRED EMBODIMENTS

Compliance

When the disclosure described in this specification is implemented, the disclosure is implemented while observing the laws of countries where the present disclosure is implemented. The disclosure described in this specification is implemented with all changes, substitutions, modifications, alterations, and corrections, which those skilled in the art can make, necessary for observing the laws of the countries.

Modes for carrying out an information processing method, an information processing device and a program according to the present disclosure are explained with reference to the drawings.

### System Configuration

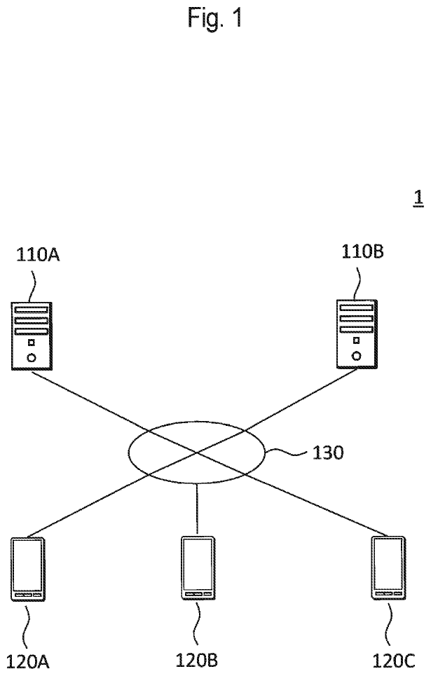

FIG. 1 shows the configuration of a communication system 1 for effectively implementing an information processing method according to an embodiment of the present disclosure. As disclosed in FIG. 1, in the communication system 1, a server 110A, a server 100B, a terminal 120A, a terminal 120B, and a terminal 120C are connected via a network 130. The server 110A, the server 110B, the terminal 120A, the terminal 120B, and the terminal 1200 configure a distributed ledger (hereafter referred to as “blockchain” as well). In the present disclosure, the blockchain is explained as a public-type configuration without a central administrator. However, the blockchain is not limited to this and may be a private type or a consortium type.

In the present disclosure, when it is unnecessary to distinguish the server 110A and the server 110B from each other, the server 110A and the server 110B may be respectively represented as servers 110.

In the present disclosure, when it is unnecessary to distinguish the terminal 120A, the terminal 1203, and the terminal 120C from one another, the terminal 120A, the terminal 1203, and the terminal 120C may be respectively represented as terminals 120.

In the present disclosure, when it is unnecessary to distinguish the servers 110 and the terminals 120 from each other, the servers 110 and the terminals 120 may be respectively represented as information processing devices 200. The number of the information processing devices 200 connected to the network 130 is not limited.

The servers 110 provide predetermined services to the terminals 120 used by users via the network 130. The predetermined services include, not as limitations but as examples, a settlement service, an electronic commerce service, an SNS (Social Networking Service) represented by an instant messenger, a content provision service of music, moving images, books, and the like, and a financial service. The users use the predetermined services via the terminals 120, whereby the servers 110 can provide the predetermined services to one or more terminals 120.

According to necessity, a terminal used by a user X is represented as a terminal 120X. User information in the predetermined service associated with the user X or the terminal 120X is represented as user information X. The user information is information of a user associated with an account used by the user in the predetermined service. The user information includes, not as limitations but as examples, information associated with the user such as a name of the user, an icon image of the user, age of the user, sex of the user, an address of the user, interests and tastes of the user, and an identifier of the user input by the user or given by the predetermined service. The user information may be any one or a combination of these kinds of information.

The network 130 plays a role of connecting two or more information processing devices 200. The network 130 means a communication network that provides a connection route such that data can be transmitted and received after the terminals 120 are connected to the servers 110.

One or a plurality of portions of the network 130 may be a wired network or a wireless network. The network 130 can include, not as limitations but as examples, an ad hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of a public switched telephone network (PSTN), a cellular phone network, ISDNs (Integrated Service Digital Networks), wireless LANs, an LTE (Long Term Evolution), a CDMA (Code Division Multiple Access), a Bluetooth (registered trademark), and satellite communication or a combination of two or more of the foregoing. The network 130 can include one or a plurality of networks 130.

The information processing device 200 may be any information processing device if the information processing device 200 is an information processing device that can realize processing, functions, and/or methods described in the present disclosure.

The information processing device 200 includes, not as limitations but as examples, a smartphone, a cellular phone (a feature phone), a computer (as not limitations but as examples, a desktop computer, a laptop computer, a tablet computer, and the like), a server device, a media computer platform (not as limitations but as examples, a cable, a satellite set-top box, a digital video recorder, and the like), a hand-held computer device (not as limitations but as example, a PDA (Personal Digital Assistant), an electronic mail client, and the like), a wearable terminal (not as limitations but as examples, an eyeglass-type device, a watch-type device, and the like), other types of computers, or a communication platform.

### Hardware Configuration

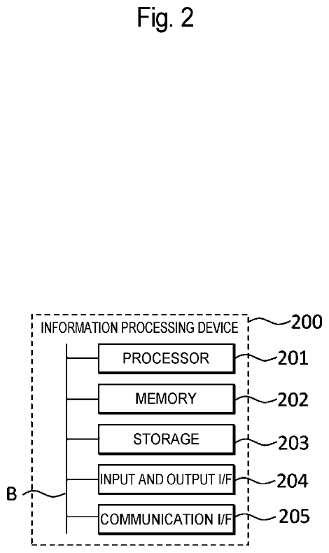

A hardware configuration of the information processing device 200 included in the communication system 1 is explained with reference to FIG. 2.

The information processing device 200 includes a processor 201, a memory 202, a storage 203, an input and output interface (input and output I/F) 204, and a communication interface (communication I/F) 205. The components of hardware of the information processing device 200 are connected to one another, not as a limitation but as an example, via a bus B.

The information processing device 200 realizes the processing, the functions, and/or the methods described in the present disclosure according to cooperation of the processor 201, the memory 202, the storage 203, the input and output I/F 204, and the communication I/F 205.

The processor 201 executes processing, functions, and/or methods realized by codes or commands included in programs stored in the storage 203. The processor 201 includes, not as limitations but as examples, a central processing unit (CPU), an MPU (Miro Processing Unit), GPU (Graphics Processing Unit), a microprocessor, a processor core, a multiprocessor, an ASIC (Application-Specific Integrated Circuit), and an FPGA (Field Programmable Gate Array). The processor 201 may realize respective kinds of processing disclosed in embodiments with a logic circuit (hardware) and a dedicated circuit formed in an integrated circuit (IC) chip, an LSI (Large Scale Integration), or the like. These circuits may be realized by one or a plurality of integrated circuits. A plurality of kinds of processing explained in the embodiments may be realized by one integrated circuit. The LSI is sometimes called VLSI, super LSI, ultra LSI, or the like according to a difference in a degree of integration.

The memory 202 temporarily stores a program loaded from the storage 203 and provides a work area to the processor 201. Various data generated while the processor 201 is executing the program are also temporarily stored in the memory 202. The memory 202 includes, not as limitations but as examples, a RAM (Random Access Memory) and a ROM (Read Only Memory).

The storage 203 stores programs. The storage 203 includes, not as limitations but as examples, a HDD (Hard Disk Drive), an SSD (Solid State Drive), and a flash memory.

The communication I/F 205 performs transmission and reception of various data via the network 130. The communication may be executed by either wire or radio. Any communication protocol may be used if mutual communication can be executed. The communication I/F 205 executes communication with the other information processing devices via the network 130. The communication I/F 205 transmits various data to the other information processing devices according to an instruction from the processor 201. The communication I/F 205 receives various data transmitted from the other information processing devices and transmits the data to the processor 201.

The input and output I/F 204 includes an input device that inputs various kinds of operation to the information processing device 200 and an output device that outputs a processing result of processing in the information processing device 200. In the input and output I/F 204, the input device and the output device may be integrated or may be separated.

The input device is realized by any one of all kinds of devices that can receive an input from the user and transmit information, concerning the input to the processor 201 or a combination of the devices. The input device includes, not as limitations but as examples, hardware keys such as a touch panel, a touch display, and a keyboard, a pointing device such as a mouse, a camera (an operation input via an image), and a microphone (an operation input by voice).

The output device is realized by any one of all kinds of devices that can output a processing result of processing in the processor 201 or a combination of the devices. When the output device outputs the processing result as a video and/or a moving image, the output device is realized by any one of all kinds of devices that can display, according to display data written in a frame buffer, the display data or a combination of the devices. The output device includes, not as limitations but as examples, a touch panel, a touch display, a monitor (not as limitations but as examples, a liquid crystal display, an GELD (Organic Electroluminescence Display), and the like), a head mounted display (HMD), projection mapping, a hologram, a device capable of displaying an image, text information, and the like in the air (which may be vacuum), a speaker (voice output), and a printer. These output devices may be capable of displaying display data in 3D.

Programs in the embodiments of the present disclosure may be provided in a state in which the programs are stored in a computer-readable storage medium. The storage medium is capable of storing the programs in a “non-transitory tangible medium”. The programs include, not as limitations but as examples, a software program and a computer program.

In an appropriate case, the storage medium can include one or a plurality of semiconductor-based or other integrated circuits (ICs) (not as limitations but as examples, a field programmable gate array (FPGA), an application specific IC (ASIC), and the like), a hard disk drive (HDD), a hybrid hard drive (HHD), an optical disk, an optical disk drive (ODD), a magneto-optical disk, a magneto-optical drive, a floppy diskette, a floppy disk drive (FDD), a magnetic tape, a solid-state drive (SSD), a RAM drive, a secure digital card or drive, any other appropriate storage medium, and an appropriate combination of two or more of the foregoing. In an appropriate case, the storage medium may be a volatile storage medium, a nonvolatile storage medium, or a combination of the volatile and nonvolatile storage medium.

A program of the present disclosure may be provided to the information processing device 200 via any transmission medium (a communication network, a broadcast wave, or the like) capable of transmitting the program.

The embodiments of the present disclosure can also be realized in a form of a data signal embedded in a carrier wave, the program being embodied in the data signal by electronic transmission.

The program of the present disclosure is implemented using, not as limitations but as examples, script languages such as JavaScript (registered trademark) and Python, programming languages such as a C language, a Go language, Swift, Kotlin, and Java (registered trademark), and the like.

At least a part of the processing, the functions, or the methods in the information processing device 200 may be realized by cloud computing configured by one or more computers.

At least a part of the processing, the functions, or the methods in the information processing device 200 may be performed by the other information processing devices. In this case, at least a part of processing, functions, or methods of units realized by the processor 201 may be performed by the other information processing devices.

### Others

Unless explicitly referred to otherwise, the configuration of the determination in the embodiments of the present disclosure is not essential. Predetermined processing may be operated when a determination condition is satisfied or the predetermined processing may be performed when the determination condition is not satisfied.

In the present disclosure, “or” has an inclusive meaning rather than an exclusive meaning unless clearly described otherwise or unless indicated otherwise by a context. Therefore, in the present disclosure, “A or B” means “A, B, or both of A and B” unless clearly described otherwise or unless indicated otherwise by a context. Further, “and” has meanings of both of joint and several unless clearly described otherwise or unless indicated otherwise by a context. Therefore, in this specification, “A and B” means “A and B, jointly or severally” unless clearly described otherwise or unless indicated otherwise by a context. Further, “a”, “an”, or the means “one or a plurality” unless clearly described otherwise or unless indicated otherwise by a context. Therefore, in this specification, “an A” or “the A” means “one or plurality of As” unless particularly clearly described otherwise or unless indicated otherwise by a context.

The present disclosure includes all changes, substitutions, modifications, alternations, and corrections that those skilled in the art can make for the embodiments and/or examples of the present disclosure. Similarly, in an appropriate case, the appended claims include all changes, substitutions, modifications, alternations, and corrections that those skilled in the art can make for the embodiments and/or the examples of the present disclosure. Further, the present disclosure includes any combinations of one or a plurality of characteristics of the embodiments and/or the examples in the present disclosure and one or a plurality of characteristics of other embodiments and/or examples in the present disclosure that those skilled in the art can make.

In addition, reference in the appended claims to a device or a system or components of the device or the system that are adapted or disposed, have abilities, are configured, are usable, are operable, or can operate to implement specific processing, functions, and/or methods include the device, the system, or the components irrespective of whether the device, the system, or the components or the specific processing, functions, and/or methods of the device, the system, or the components are activated, turned on, or unlocked as long as the device, the system, or the components are adapted or disposed, have abilities, are configured, are usable, are operable, or can operate in that way.

Embodiments according to an example of the present disclosure are explained below with reference to the drawings. However, the embodiments explained below are only illustrations and are not intended to exclude application of various modifications and techniques not clearly described below. That is, the example of the present disclosure can be carried out while being variously modified in a range not departing from the gist of the present disclosure. In the following description of the drawings, the same or similar portions are denoted by the same or similar reference numerals and signs. The drawings are schematic and do not always coincide with actual dimensions, ratios, and the like. Further, portions having different relations and ratios of dimensions of the drawings are sometimes included among the drawings.

### Terms

Before the embodiments are specifically explained, first, terms used in this disclosure are explained.

“Blockchain network” in the present disclosure refers to a network that shares information concerning a blockchain configured by two or more information processing devices 200 that communicate according to predetermined communication protocol. As an example, the blockchain network is a P2P network. Nodes participating in the blockchain network can directly share information concerning the blockchain one another via the network 130. In the following explanation, as an example, it is assumed that transaction information is transmitted to the network 130 by broadcast communication. However, the transaction information is not limited to this and may be transmitted by unicast communication or multicast communication. The transaction information broadcasted to the blockchain network is received by the information processing devices 200 connected to the blockchain network. As an example, the broadcasted transaction information is stored in a block by any information processing device 200 among the information processing devices 200 that receive the transaction information. When the block, in which the transaction information is stored, is transmitted (e.g., broadcasted) to the network 130, the information processing devices 200 connected to the blockchain network receive the block, perform consensus building through an algorithm such as PoW (Proof of Work) or PoS (Proof of Stake), and connect the block after a finally decided block to record the block.

“Smart contract” in the present disclosure refers to a program for causing an information processing device to automatically execute a series of processing on the basis of a certain condition. As an example, the smart contract can be implemented in a distributed application platform such as Ethereum. However, implementation means is not limited to this. As an example, in a distributed application, a user account managed by a user and a contract account that executes a contract code (the smart contract) on the basis of transaction information and the like received from the user account may be defined. For example, transaction information broadcasted from the user account to the blockchain network is received by the information processing devices 200 connected to the blockchain network. The contract account can execute the contract code on the basis of the transaction information and perform a predetermined series of processing. A code (the smart contract) of the distributed application is incorporated in the blockchain and cannot be falsified by a mechanism of PoW. The code is executed on a node participating in the blockchain network. A state of a result of the execution of the code is also incorporated in the blockchain and cannot be falsified. It is also possible to transmit money to the contract account besides instructing execution of the contract code.

“Account” in the present disclosure refers to an account on the blockchain network. Examples of the account include, besides one or a plurality of user accounts of the user, one or a plurality of contract accounts that execute the contract code (the smart contract). In the present disclosure, an account that automatically executes, according to predetermined conditions such as reception of notifications from second to fourth accounts, a series of processing corresponding to the conditions is referred to as first account, an account of a seller user that receives a consideration and performs goods sales and the like is referred to as second account, an account of a purchaser user that pays a consideration and performs goods purchase and the like is referred to as third account, an account of an escrow user that performs mediation of a transaction between the purchaser user and the seller user is referred to as fourth account, and information processing devices associated with the first to fourth accounts are respectively referred to as first to fourth information processing devices.

In the present disclosure, a consideration and a guarantee charge are deposited into the first account rather than the fourth account. Therefore, examples of “mediation” of a transaction performed by the escrow user include mediation performed when a situation outside a category of predetermined processing occurs in the smart contract. Details of the mediation are explained below.

In the present disclosure, “consideration” is a consideration paid to the seller user by the purchaser user for goods or services and “guarantee charge” is a guarantee charge paid to the escrow user as a renumeration for mediation of a transaction. A price of goods or services may be “consideration” and “guarantee charge” may be applied separately from the price. A part of the price of goods or services may be “consideration” and the remaining part of the price of goods or services may be “guarantee charge”. Deposit and payment of the consideration and the guarantee charge can be performed by payment from an account or the like, use of a money equivalent (a point, a coupon, an electronic money, or the like) usable in a specific service, use of advance money by a credit card, or the like and can also be performed by use of a virtual asset. A deposit and payment method other than the virtual asset usable in the blockchain network can be realized by enabling the first account to access an external system (e.g., an account management system of a bank) constructed by a server operated by another operator (a third party) or another business department. However, the method is not limited to this.

“Virtual asset” in the present disclosure indicates a virtual currency or a transactable asset equivalent to the virtual currency. “Virtual currency” means, in principle, a virtual currency prescribed in Article 2(5)(i) and (ii) of the Fund Settlement Law (Law No. 59 in 2009) or a virtual currency equivalent to the virtual currency and a virtual currency that circulates as electronic data without having a real thing such as a bill or a coin, can be used as a consideration of goods and services among an unspecified large number of people through a network, and is sold and purchased in a dedicated exchange or shop without presence of a public issuing entity and an administrator such as a central bank, and can be exchanged with a substantive currency such as yen, dollar, or euro. However, the virtual currency is not limited to this.

### First Embodiment

A first embodiment is an embodiment in which, in a transaction system in which a transaction between a second account (hereinafter referred to as “seller account” as well) that, for example, sells goods and a third account (hereinafter referred to as “purchaser account” as well) that pays a consideration is mediated by a fourth account (hereinafter referred to as “escrow account” as well), a consideration received by the second account (the seller account) and a guarantee charge received by the fourth account (the escrow account) is deposited into a first account (hereinafter referred to as “contract account” as well) and, when a predetermined condition is satisfied, settlement processing for transferring the deposited consideration to the second account (the seller account) and transferring the guarantee charge to the fourth account (the escrow account) is performed to thereby guarantee security of the transaction between the seller and the purchaser and guarantee reliability of a mediation job performed by the escrow user.

In the first embodiment, the communication system 1 is constructed by connecting, via the network 130, a first information processing device (hereinafter referred to as “contract information processing device” as well) 200A that performs processing based on a contract code, a second information processing device (hereinafter referred to as “seller information processing device” as well) 2003 used by the seller user, a third information processing device (hereinafter referred to as “purchaser information processing device” as well) 200C used by the purchaser user, and a fourth information processing device (hereinafter referred to as “escrow information processing device” us well) 200D used by the escrow user. Such a communication system may be configured as a part of a transaction system of goods or services.

The purchaser information processing device 200C is an example of an information processing device associated with the purchaser account. The purchaser user can perform, using the purchaser information processing device 200C, purchase of goods or services presented by the seller user. At this time, the purchaser user can create transaction information at predetermined timing using the purchaser information processing device 200C and transmit the transaction information to the blockchain network with the contract account set as a destination. The transaction information includes, for example, information concerning goods or services set as a transaction target, a consideration of the goods or services and a guarantee charge for the transaction, and information concerning the seller account and the purchaser account, and information concerning the escrow account selected out of a plurality of candidates. When the purchaser user receives goods or services, the purchaser information processing device 2000 creates a notification to that effect and transmits the notification to the blockchain network with the contract account set as a destination.

Further, prior to the transmission of the transaction information, the purchaser information processing device 200C can also create prior information used for determination of the escrow account that performs mediation of the transaction, transmit the prior information to the blockchain network with the contract account set as a destination, and perform, via the contract account, a consensus building process necessary for the determination of the escrow account. The prior information includes information concerning goods or services set as a transaction target, a consideration of the goods or services and a desired guarantee charge, and information concerning the seller account and the purchaser account.

The contract information processing device 200A is an example of an information processing device associated with the contract account. When receiving transaction information to the effect that a consideration of goods or services and a guarantee charge are deposited, the contract information processing device 200A performs deposit processing for temporarily keeping the consideration and the guarantee charge and transmitting, on the basis of the received transaction information, a dispatch instruction to the seller account.

Subsequently, when receiving, concerning the transaction information for which the deposit processing is performed, from the purchaser account that deposits the consideration, a result notification to the effect that goods or services are received, the contract information processing device 200A performs settlement processing for transferring the consideration from the contract account to the seller account and transferring the guarantee charge from the contract account to the escrow account. Consequently, it is possible to guarantee security of the transaction between the seller account and the purchaser account and guarantee reliability of the mediation job of the escrow account.

The seller information processing device 200B is an example of an information processing device associated with the seller account. The seller information processing device 200E can create information concerning goods sold or services provided at any timing and enable the purchaser information processing device 200C to view the information via the network 130. When the purchaser account creates transaction information in purchasing any goods or services and transmits the transaction information to the blockchain network, the seller information processing device 200B receives a dispatch instruction from the contract account. The dispatch instruction may include, as information included in information concerning the transaction information, for example, indication to the effect that the consideration is deposited into the contract account and information serving as a standard of a dispatch date or an arrival date of goods or a provision date of services besides information concerning goods or services set as a transaction target, a consideration of the goods or the services and a guarantee charge of the transaction, and information concerning the seller account, a purchaser account, and an escrow 4 account.

When the seller user performs dispatch or the like of goods or provision or the like of services, the seller information processing device 2003 can create a notification to that effect and transmit the notification to the blockchain network with the contract account set as a destination. Further, prior to the reception of the information concerning the transaction information, the seller information processing device 2003 can receive information concerning the prior information from the contract account and perform, via the contract account, consensus building process necessary for determination of the escrow account.

The escrow information processing device 200D is an example of an information processing device associated with the escrow account. When a transaction to be mediated is determined, the escrow information processing device 200D receives a determination notification from the contract account. The determination notification may include, besides the information illustrated in the transaction information, indication to the effect that a guarantee charge is deposited into the contract account and information serving as a standard of a dispatch date or an arrival date of goods or a provision date of services. Prior to the reception of the determination notification, the escrow information processing device 200D can receive the information concerning the prior information from the contract account and perform the consensus building process necessary for the determination of the escrow account via the contract account.

### Effects of the First Embodiment

According to the first embodiment explained above, in addition to escrow for a goods transaction performed by depositing a consideration of goods into the contract account and, when a predetermined condition is satisfied, paying the deposited consideration to the seller account, it is possible to perform escrow for a mediation job by depositing a guarantee charge into the contract account and, when a predetermined condition is satisfied, paying the deposited guarantee charge to the escrow account. That is, the consideration is not deposited into the escrow account, and the escrow account performs only mediation of a transaction and, when achieving the mediation, receives a mediation fee in a form of a guarantee charge. Consequently, it is possible to guarantee security of the transaction between the seller account and the purchaser account and guarantee reliability of a mediation job of the escrow account.

### Functional Configuration in the First Embodiment

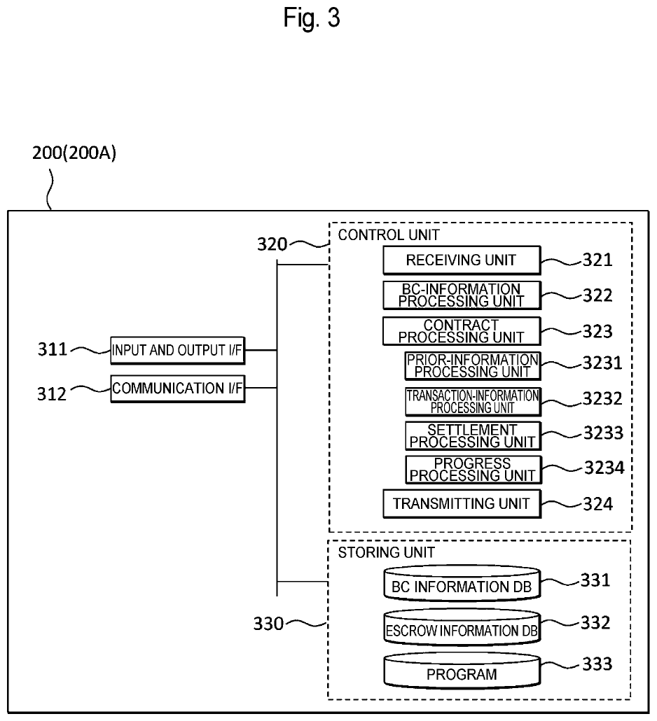

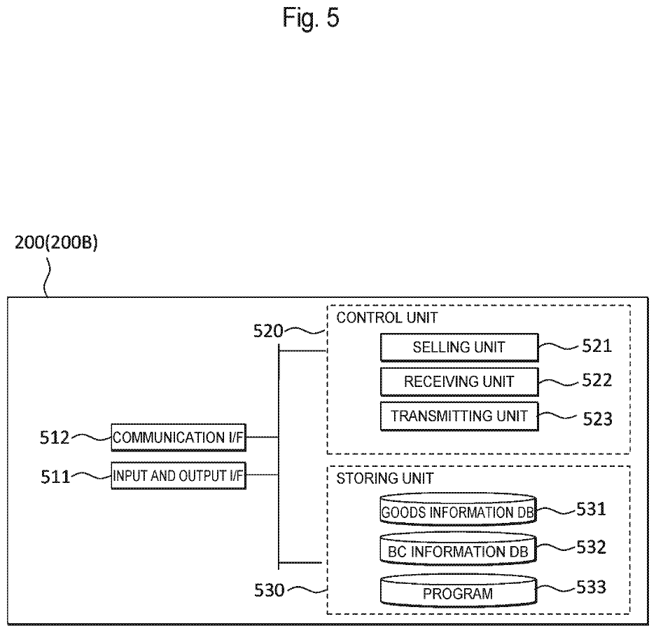

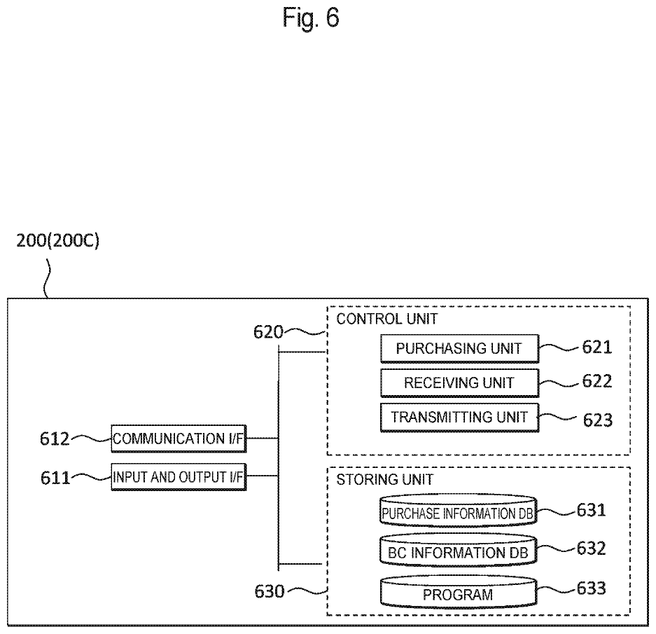

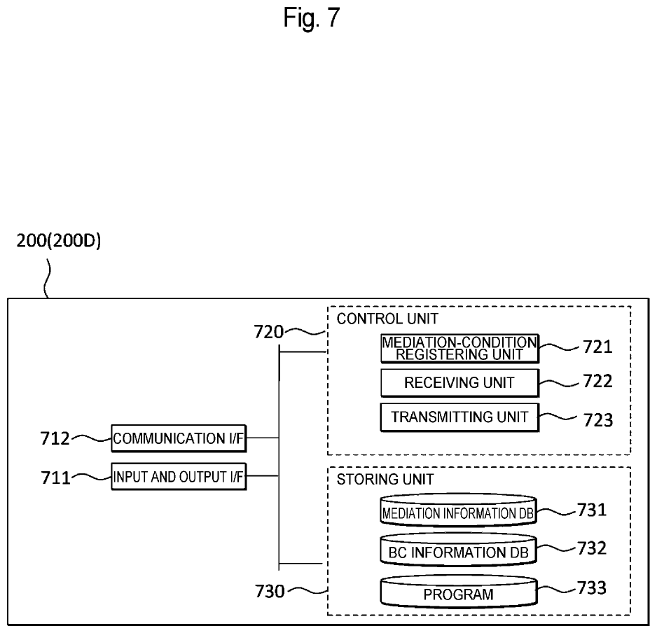

Functional configurations of the first information processing device (the contract information processing device) 200A, the second information processing device (the seller information processing device) 2003, the third information processing device (the purchaser information processing device) 200C, and the fourth information processing device (the escrow information processing device) 200D are explained with reference to FIGS. 3 to 7.

FIGS. 3 and 5 to 7 show examples of block diagrams showing the configurations of the information processing devices 200A to 200D according to the first embodiment. Functional units disclosed in FIGS. 3 and 5 to 7 are realized by cooperation of the processor 201, the memory 202, the storage 203, the input and output I/F 204, and the communication I/F 205 included in the information processing device 200. That is, the processor 201 of the information processing device 200 shown in FIG. 2 develops, on the memory 202 (e.g., the RAM), various programs (a control program, an arithmetic program, and the like) stored in the storage 203. The processor 201 interprets and executes the various programs developed on the memory 202 and controls the hardware components to thereby realize a functional configuration explained below.

Functions realized by the information processing devices 200A to 200D may be realized by the processor 201 such as a general-purpose CPU or a part or all of the functions may be realized by one or a plurality of dedicated processors 201. Further, in the functional configuration realized by the information processing devices 200A to 200D, omission, substitution, and addition of functions may be performed as appropriate according to the embodiments or the examples.

### (1) Functional Configuration of the Contract Information Processing Device 200A

The contract information processing device 200A is an example of an information processing device associated with the contract account. The contract information processing device 200A includes an input and output I/F 311, a communication I/F 312, a control unit 320, and a storing unit 330. The input and output I/F 311 is equivalent to the input and output I/F 204 shown in FIG. 2. The communication I/F 312 is equivalent to the communication I/F 205 shown in FIG. 2. The storing unit 330 is realized using the memory 202 and/or the storage 203. The control unit 320 includes a receiving unit 321, a BC-information processing unit 322, a contract processing unit 323, and a transmitting unit 324. The contract processing unit 323 performs information processing based on a contract code as explained below. When being subdivided for each of types of such information processing, the contract processing unit 323 can include, for example, a prior-information processing unit 3231, a transaction-information processing unit 3232, a settlement processing unit 3233, and a progress processing unit 3234.

A BC information DB 331, an escrow information DB 332, and a program 333 are stored in the storing unit 330. The receiving unit 321, the BC-information processing unit 322, the contract processing unit 323, and the transmitting unit 324 are realized by the processor 201 reading out and executing the program 333 stored in the storing unit 330. Consequently, the communication system 1 for performing a transaction with security and reliability guaranteed is constructed. The storing unit 330 is explained below. Then, the control unit 320 is explained.

The BC information DB 331 is an example of a database that stores information received from the second account to the fourth account by the receiving unit 321 via the blockchain network and information transmitted to the second account to the fourth account by the transmitting unit 324 via the blockchain network. Information concerning goods or services and information capable of identifying the seller account are desirably recorded in the BC information DB 331 in association with each other. The BC information DB 331 may store all kinds of information transmitted to the blockchain network. For example, a contract code for causing the contract processing unit 323 explained below to execute predetermined processing may be stored in the BC information DB 331.

Examples of information received from the seller account and/or the purchaser account by the receiving unit 321 via the blockchain network include prior information and transaction information. Example of the information received from the seller account include a notification concerning dispatch of goods. Further, examples of information received from the purchaser account include a notification concerning arrival of the goods. Examples of information received from the escrow account include a notification concerning contract of mediation of a transaction. Besides the above, examples of the transaction information received by the contract account include a reply notification to notifications sent to the accounts for progress confirmation of the transaction.

Examples of information transmitted to the seller account by the transmitting unit 324 via the blockchain network include information concerning candidates of escrow, information concerning transaction information, and information concerning settlement of a consideration. Examples of information transmitted to the purchaser account include information concerning candidates of escrow. Further, examples of information transmitted to the escrow account include information concerning candidates of a transaction for which escrow is possible, information concerning transaction information, and information concerning settlement of a guarantee charge. Besides the above, examples of transaction information received by the contract account include a notification sent to the accounts for confirmation of progress of the transaction.

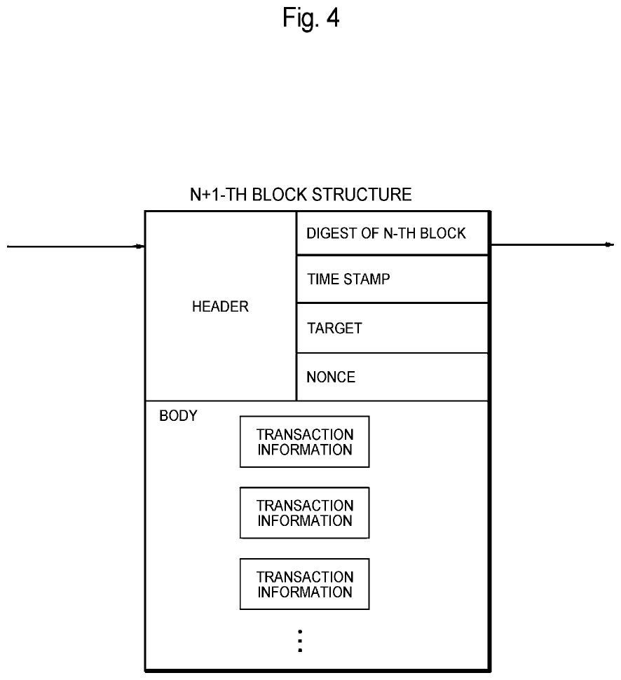

FIG. 4 is a diagram schematically showing a part of a data structure stored by the BC information DB 331 and is a diagram showing the structure of an N+1-th block among blocks arranged in time-series order. For example, a digest, a time stamp, a target, and a nonce of an N-th block are stored in a header of the N+1-th block. The target refers to a value used when mining is performed using the existing technique of PoW (Proof of Work). The nonce refers to any value. The mining is specifically explained. The information processing device 200 (a blockchain node), which performs the mining, repeatedly performs calculation (mining) of a digest of a block header while changing a value of the nonce for the purpose of finding a nonce, a digest of a block header of which is equal to or smaller than the target. When an appropriate nonce is found, the information processing device 200, which performs the mining, stores the found nonce and creates a block. Since a probability of a digest of a block header including any nonce to be equal to or smaller than the target is extremely small, the mining is work requiring excessively large cost. The mining is not limited to a configuration in which the technique of PoW is used. For example, the information processing devices 200 may be configured to add a block to the end of the blockchain irrespective of whether a header of a created block is equal to or smaller than a value of the target. In this case, a block stored in the BC information DB 331 may not include the target and the nonce. Further, when the blockchain is the private type or the consortium type, the mining may not be performed. In the example shown in FIG. 4, a plurality of kinds of transaction information or a plurality of notifications are stored in a body of a block.

Information included in the prior information and the transaction information among the information stored by the EC information DB 331 is explained below.

The prior information includes, as information used by the prior-information processing unit 3231 in performing extraction processing for candidates of the escrow account, for example, information concerning goods or services set as a transaction target, a consideration of the goods or the services, an amount of a guarantee charge desired by the seller user and/or the purchaser user, and information concerning the seller account and the purchaser account.

The information concerning the goods or the services set as the transaction target includes, for example, besides a specific name of the goods or the services, information concerning a category (e.g., vegetable and fruit or an electronic device) of the goods or the services.

As the amount of the guarantee charge desired by the seller user and/or the purchaser user, for example, an amount of a guarantee charge desired by one of the seller user and the purchaser user concerning individual transaction of goods or services and an amount of a guarantee charge consented in advance by the seller user and the purchaser user prior to a transaction are stored.

Further, the information concerning the seller account and the purchaser account, for example, credit information of the seller account and the purchaser account based on a transaction history in the past, transaction achievement result of the seller account and the purchaser account, and location information of the seller account and the purchaser account related to transportation of goods. The BC-information processing unit 322 of the contract information processing device 200A may create the credit information of the seller account and the purchaser account from transaction history stored in the distributed ledger (the blockchain) and store the credit information as a part of the prior information.

In the transaction information, as information used by the transaction-information processing unit 3232 in performing the deposit processing, for example, information concerning goods or services set as a transaction target, information to the effect that a consideration and a guarantee charge are deposited into the contract account, and information concerning the second account to the fourth account are stored.

As the information concerning the goods or the services set as the transaction target, the same information as the information illustrated in the prior information is illustrated. When a virtual asset usable in the blockchain network is deposited, examples of the information indicating that a consideration and a guarantee charge is deposited into the contract account include information to the effect that a consideration and a guarantee charge are transferred from the accounts to the contract account. When an asset other than the virtual asset usable in the blockchain network is deposited, examples of the information indicating that a consideration and a guarantee charge is deposited into the contract account include information for enabling the first account to access an external system (e.g., an account management system of a bank) constructed by a server operated by another operator (a third party) or other business department. However, the information indicating that a consideration and a guarantee charge is deposited into the contract account is not limited to the above and only has to be information for depositing the consideration and the guarantee charge into the contract account.

Examples of the information concerning the second account to the fourth account include information concerning addresses (identifiers) of the accounts and information concerning a depositing destination of the deposited consideration and the deposited guarantee charge.

The escrow information DB 332 is an example of a database that stores information concerning escrow users to be candidates of the escrow account. The prior-information processing unit 3231 extracts candidates of the escrow account out of the information.

In the escrow information DB 332, for example, as information registered in the escrow information DB 332 in advance by the escrow user, information concerning a category of goods or services that can be mediated by the escrow user, information concerning an upper limit and a lower limit of a consideration that can be mediated, an amount of a desired guarantee charge, and credit information of the seller account and the purchaser account that can be mediated are stored.

In the escrow information DB 332, as credit information of the escrow user based on a mediation history in the past and mediation achievement information of mediation actually performed by the escrow user, information not registered by the escrow user such as information concerning goods or services, and information concerning a consideration and a guarantee charge may be stored. The BC-information processing unit 322 of the contract information processing device 200A can create the credit information and the mediation achievement information of the escrow user from the transaction history stored in the distributed ledger (the blockchain) and store the credit information and the mediation achievement information of the escrow user in the escrow information DB 332 as a part of the prior information.

The control unit 320 is explained below.

The receiving unit 321 has a function of performing processing for receiving, via the input and output I/F 204, from the seller information processing device, the purchaser information processing device, and the escrow information processing device, the prior information, the transaction information, and other notifications transmitted to the blockchain network.

The BC-information processing unit 322 has a function of performing value output processing on the basis of a transaction history stored in the BC information DB 331. For example, the BC-information processing unit 322 can perform processing for creating credit information of the seller account, the purchaser account, and the escrow account on the basis of the transaction history.

The credit information of the seller account and the purchaser account can be created considering, for example, elements that deteriorate reliability of a transaction such as a failure of a transaction and a delay of communication due to faults of the accounts and elements that improve the reliability of the transaction such as rapidity of communication and goods dispatch. The credit information of the escrow account can be created considering, for example, when a trouble occurs in a transaction, whether mediation with high satisfaction can be performed as escrow. Further, besides the above, evaluations given from the accounts to the other accounts at timing such as timing after a transaction end can also be considered in creating the credit information.

The created credit information can be used as, for example, besides a base for determining whether the seller user and the purchaser user perform a transaction each other, a base for determining whether the escrow user performs mediation of the transaction. The credit information may be considered as an element for determining an amount of the guarantee charge in performing the transaction. For example, when both of the credibility of the seller account and the credibility of the purchaser account are high, it is possible to reduce an amount of the guarantee charge to meet a transaction risk. When the credibility of the escrow account is high, the amount of the guarantee charge may be increased to meet the credibility of the escrow.

The BC-information processing unit 322 may create, together with the credit information, information concerning a guarantee charge corresponding to the credit information. For example, a range of the guarantee charge that can be presented for each of the accounts can be determined as information concerning the guarantee charge to make it possible to present a lower guarantee charge to the seller account and the purchaser account having high credibility and make it possible to present a higher guarantee charge to the escrow account having high credibility. A minimum guarantee charge that can be presented by the seller account and the purchaser account having low credibility may be set high. A minimum guarantee charge that can be presented by the escrow account having low credibility may be set low. However, an actual amount of the guarantee charge can be determined for each of transactions in a range of the guarantee charge that the accounts participating in the transaction can present.

The credit information created by the BC-information processing unit 322 and the information concerning the guarantee charge corresponding to the credit information may be stored in a management table in the BC information DB 331 in association with the accounts. The credit information of the escrow account and the information concerning the guarantee charge corresponding to the credit information may be stored in the escrow information DB 332. Further, a code for causing the prior-information processing unit 3231 to execute processing may be a code for extracting, on the basis of an amount of the guarantee charge desired by the seller account and/or the purchaser account stored in the prior information and information concerning the guarantee charge associated with the escrow account stored in the escrow information DB 332, candidates of the escrow user capable of mediating the transaction.

The contract processing unit 323 has a function of performing information processing based on a contract code when a predetermined condition is satisfied. When being subdivided for each of types of such information processing, the contract processing unit 323 can include, for example, the prior-information processing unit 3231, the transaction-information processing unit 3232, the settlement processing unit 3233, and the progress processing unit 3234.

The prior-information processing unit 3231 has, for example, a function of performing, when receiving the prior information, processing for extracting, on the basis of the prior information and the information stored in the escrow information DB 332, candidates of the escrow user capable of mediating a transaction and a function of performing processing for transmitting notification to the seller account and/or the purchaser account via the transmitting unit 324. When transmitting the candidates of the escrow user to the seller account and/or the purchaser account, the prior-information processing unit 3231 can transmit information concerning the credibility of the candidates and/or the guarantee charge necessary for selecting the candidates. In this case, the seller account and/or the purchaser account selects the escrow account that mediates the transaction out of the candidates of the escrow user and transmits transaction information including the selected escrow account to the contract account. Before the transmission of the transaction information, a consensus building process for confirming the escrow user selected as the escrow account whether the escrow user consents to mediation of the transaction may be interposed.

Instead of the above, the prior-information processing unit 3231 has a function of performing processing for, when receiving the prior information, extracting, on the basis of the prior information and the information stored in the escrow information DB 332, candidates of the escrow user capable of mediating a transaction, a function of performing processing for transmitting information concerning the prior information to one or a plurality of escrow users to be candidates, and a function of performing processing for, when receiving, from the escrow users to be the candidates, notification to the effect that mediation of the transaction is desired, transmitting information concerning the candidates to the seller account and/or the purchaser account. The information concerning the candidates may include information concerning the credibility of the candidates and/or the guarantee charge necessary for selecting the candidates. In this case, the seller account and/or the purchaser account selects the escrow account that mediates the transaction out of the received candidates and transmits transaction information including the selected escrow account to the contract account.

The transaction-information processing unit 3232 has, for example, a function of performing, when receiving the transaction information, deposit processing for temporarily keeping a consideration and a guarantee charge and a function of performing processing for transmitting, via the transmitting unit 324, information concerning the transaction information to the seller account. The transaction-information processing unit 3232 may transmit the information concerning the transaction information to the escrow account.

The settlement processing unit 3233 has a function of performing, for example, when receiving a notification concerning arrival or the like of goods from the purchaser account, settlement processing for moving the deposited consideration to the seller account and transferring the guarantee charge to the escrow account. When not receiving a notification of dispatch or the like of goods from the seller account, the settlement processing unit 3233 can perform settlement processing for paying back the deposited consideration and the deposited guarantee charge from the contract account to the purchaser account.

The progress processing unit 3234 has, for example, a function of performing processing for, when not receiving a notification concerning dispatch or the like of goods from the seller account for a fixed period or more, transmitting a notification requesting the seller account and/or the escrow account to issue a situation report and a function of performing processing for, when not receiving a notification concerning arrival or the like of goods from the purchaser account for a fixed period or more, transmitting, via the transmitting unit 324, a notification requesting the purchaser account and/or the escrow account to issue a situation report.

The transmitting unit 324 has a function of performing processing for transmitting, on the basis of an instruction of the contract processing unit 323, respective kinds of information to the blockchain network via the input and output I/F 204.

### (2) Functional Configuration of the Seller Information Processing Device 200B

The seller information processing device 200B is an example of an information processing device associated with the seller account and includes an input and output I/F 511, a communication I/F 512, a control unit 520, and a storing unit 530. The input and output I/F 511 is equivalent to the input and output I/F 204 shown in FIG. 2. The communication I/F 512 is equivalent to the communication I/F 205 shown in FIG. 2. The control unit 520 includes a selling unit 521, a receiving unit 522, and a transmitting unit 523. The storing unit 530 includes a goods information DB 531, a BC information DB 532, and a program 533. The selling unit 521, the receiving unit 522, and the transmitting unit 523 are realized by the processor 201 reading out and executing the program 533 stored in the storing unit 530. The storing unit 530 is realized using the memory 202 and/or the storage 203. The storing unit 530 is explained below. Then, the control unit 520 is explained.

The goods information DB 531 is an example of a database in which goods dealt with by the seller user are stored. The goods dealt with by the seller user and a management table are stored in the goods information DB 531. As an example, the goods dealt with by the seller user and a status of the goods are stored in the management table in association with each other. Examples of the statues of the goods include information such as a status during sales, a status after reception of the information concerning the transaction information and before dispatch of the goods, a status after the dispatch of the goods and before transmission of a notification concerning the dispatch or the like of the goods, a status after the transmission of the notification concerning the dispatch or the like of the goods and before settlement, and a status after the settlement. Information concerning the goods dealt with by the seller user only has to be recorded in the goods information DB 531. The goods information DB 531 does not always need to include the management table. Information concerning provided services may be included in the goods information DB 531.

The BC information CE 532 is an example of a database that stores information received from the other accounts by the receiving unit 522 via the blockchain network and information transmitted to the other accounts by the transmitting unit 324 via the blockchain network. The BC information CE 532 may store all kinds of information transmitted to the blockchain network.

The selling unit 521 has a function of disclosing goods for sale to a third party. The selling unit 521 has, for example, a function of performing processing for creating information concerning goods to be sold and a function of performing processing for enabling, via the network 130, the information concerning the goods to be sold to be viewed. The information concerning the goods to be sold is stored in the goods information CB 531. The selling unit 521 has a function of, when a status of the goods is, for example, the state after the reception of information concerning the transaction information, limiting the viewing to only the purchaser account. The selling unit 521 may have a function of disclosing provided services to the third party.

The receiving unit 522 has a function of performing processing for receiving, via the input and output I/F 204, a notification transmitted from another information processing device. The goods information DB 531 can perform, according to the received notification, processing for updating information of the management table. For example, concerning goods having the status before the reception of the information concerning the transaction information, when receiving the information concerning the transaction information, the goods information DB 531 updates the status to the status before the dispatch of the goods. When the information concerning the transaction information includes information concerning a date serving as a standard of dispatch, the goods information DB 531 stores the standard date and performs management to finish the dispatch of the goods by the standard date. When receiving settlement information to the effect that a consideration is transferred from the contract account to the seller account, the goods information DB 531 updates the status to the status after the settlement.

The transmitting unit 523 has a function of performing processing for transmitting, on the basis of an instruction received from the contract account, an input from the seller user, the status of the goods stored in the goods information DB 531, or the like, respective kinds of information to the blockchain network via the input and output I/F 204. For example, concerning the goods having the status after the dispatch of the goods and before the transmission of the notification concerning the dispatch or the like of the goods, the transmitting unit 523 performs processing for transmitting, to the contract account, a notification concerning the dispatch or the like of the goods. When performing these kinds of processing, the transmitting unit 523 updates the status of the BC information DB 532.

### (3) Functional Configuration of the Purchaser Information Processing Device 200C

The purchaser information processing device 200C is an example of the information processing device associated with the purchaser account and includes an input and output I/F 611, a communication I/F 612, control unit 620, and a storing unit 630. The input and output I/F 611 is equivalent to the input and output I/F 204 shown in FIG. 2. The communication I/F 612 is equivalent to the communication I/F 205 shown in FIG. 2. The control unit 620 includes a purchasing unit 621, a receiving unit 622, and a transmitting unit 623. The storing unit 630 includes a purchase information DB 631, a BC information DB 632, and a program 633. The purchasing unit 621, the receiving unit 622, and the transmitting unit 623 are realized by the processor 201 reading out and executing the program 633 stored in the storing unit 630. The storing unit 630 is realized using the memory 202 and/or the storage 203. The storing unit 630 is explained below. Then, the control unit 620 is explained.

The purchase information DB 631 is an example of a database in which information concerning goods applied for purchase by the purchaser user is stored. The goods applied for purchase by the purchaser user and a management table are stored in the purchase information DB 631. As an example, the goods applied for purchase by the purchaser user and a status of the goods are stored in the management table in association with each other. Examples of the status of the goods include information concerning, for example, a status after prior information transmission, a status after the prior information transmission and before transaction information transmission, a status after the transaction information transmission and before goods dispatch communication reception, a status after the goods dispatch communication reception and before goods arrival, a status after the good arrival and before transmission of a notification concerning the arrival or the like of the goods, a status after the transmission of the notification concerning the arrival or the like of the goods and before settlement, and a statue after the settlement. The information concerning the goods applied for purchase by the purchaser user only has to be recorded in the purchase information DB 631. The purchase information DB 631 does not always need to include the management table. Information concerning services may be included in the purchase information DB 631.

The BC information DB 632 is an example of a database that stores information received from the other accounts by the receiving unit 622 via the blockchain network and information transmitted to the other accounts by the transmitting unit 623 via the blockchain network. The BC information DB 632 may store all kinds of information transmitted to the blockchain network.

The purchasing unit 621 has a function of applying for purchase of goods for sale. The purchasing unit 621 has, for example, a function of creating prior information and transaction information concerning goods applied for purchase. The information concerning the goods applied for purchase is stored in the purchase information DB 631. The purchasing unit 621 may have a function of disclosing provided services to a third party.

The receiving unit 622 has a function of performing processing for receiving, via the input and output I/F 204, a notification transmitted from another information processing device. The purchase information DB 631 can perform processing for updating, according to the received notification, the information of the management table. For example, when goods dispatch communication is received, the purchase information DB 631 updates the status to the status after the status the reception of the goods dispatch communication and before goods arrival. When the goods dispatch communication includes information concerning a standard date of a result report, the purchase information DB 631 stores the standard date as well and performs management to finish the result report by the standard date.

The transmitting unit 623 has a function of performing processing for transmitting, on the basis of an instruction received from the contract account, an input from the purchaser user, the status of the goods stored in the purchase information DE 631, and the like, respective kinds of information to the blockchain network via the input and output I/F 204. For example, concerning goods having a state after prior information transmission and before transaction information transmission and for which selection of the escrow account that mediates a transaction ends, the transmitting unit 623 performs processing for transmitting transaction information for depositing a consideration into the contract account to the contract account. Concerning good having a state after goods arrival and before transmission of a notification concerning arrival or the like of the goods, the transmitting unit 623 performs processing for transmitting a result notification to the effect that the goods are received to the contract account. When these kinds of processing are performed, the purchase information DB 631 updates the status of the goods.

### (4) Functional Configuration of the Escrow Information Processing Device 200D

The escrow information processing device 200D is an example of an information processing device associated with the escrow account and includes an input and output I/F 711, a communication I/F 712, a control unit 720, and a storing unit 730. The input and output I/F 711 is equivalent to the input and output I/F 204 shown in FIG. 2. The communication I/F 712 is equivalent to the communication I/F 205 shown in FIG. 2. The control unit 720 includes a mediation-condition registering unit 721, a receiving unit 722, and a transmitting unit 723. The storing unit 730 includes a mediation information DB 731, a BC information DB 732, and a program 733. The mediation-condition registering unit 721, the receiving unit 722, and the transmitting unit 723 are realized by the processor 201 reading out and executing the program 733 stored in the storing unit 730. The storing unit 730 is realized using the memory 202 and/or the storage 203. The storing unit 730 is explained below. Then, the control unit 720 is explained.

The mediation information DB 731 is an example of a database in which information concerning a transaction mediated by the escrow user is stored. Goods mediated by the escrow user and a management table are stored in the mediation information DB 731. As an example, the goods mediated by the escrow user and a status of the goods are stored in the management table in association with each other. The status of the goods include information concerning, for example, a status after prior information transmission, a status after transaction information transmission and before goods dispatch communication reception, a status after the goods dispatch communication reception and before goods arrival, a status after the good arrival and before transmission of a notification concerning the arrival or the like of the goods, a status after the transmission of the notification concerning the arrival or the like of the goods and before settlement, and a statue after the settlement. The information concerning the transaction mediated by the escrow user only has to be recorded in the mediation information DB 731. The mediation information DB 731 does not always need to include the management table, information concerning services may be included in the mediation information DB 731.

The BC information DE 732 is an example of a database that stores information received from the other accounts by the receiving unit 722 via the blockchain network and information transmitted to the other accounts by the transmitting unit 723 via the blockchain network. The BC information DB 732 may store all kinds of information transmitted to the blockchain network.

The mediation-condition registering unit 721 has a function of performing processing for registering information concerning a transaction that can be mediated in the escrow information DB 332 of the contract information processing device 200A. As information registered in advance in the escrow information DB 332, information concerning a category of goods or services that can be mediated by the escrow user, information concerning an upper limit and a lower limit of a consideration that can be mediated, a desired amount of a guarantee charge, and credit information of the seller account and the purchaser account that can be mediated are stored. The desired amount of the guarantee charge can be determined in a range decided by information concerning a guarantee charge created by the information processing unit 322 of the contract information processing device 200A.

The receiving unit 722 has a function of performing processing for receiving, via the input and output I/F 204, a notification transmitted from another information processing device. The mediation information DB 731 can perform processing for updating the information of the management table according to the received notification. For example, when goods dispatch communication is received, the mediation information DB 731 updates the status to a status after the reception of the goods dispatch communication and before goods arrival. When the goods dispatch communication includes information concerning a standard date of a result report, the mediation information DB 731 stores the standard date as well and manages whether the result report is performed by the standard date.

The transmitting unit 723 has a function of performing processing for transmitting, on the basis of an instruction received from the contract account, the status of the goods stored in the mediation information DB 731, or the like, respective kinds of information to the blockchain network via the input and output I/F 204. For example, when a notification to the effect that there is a defect in a transaction is received from the progress processing unit 3234 of the contract information processing device 200A, the transmitting unit 723 sorts out a situation of a transaction according to the management table or the like. When a defect is not found in the transaction on the basis of transaction information, the transmitting unit 723 transmits indication to the effect that normal settlement processing is performed to the contract account. When a defect is found in the transaction, the transmitting unit 723 transmits indication to the effect that refund or goods return processing, amount reduction processing, or the like is performed to the contract account.

### Operation Processing in the First Embodiment

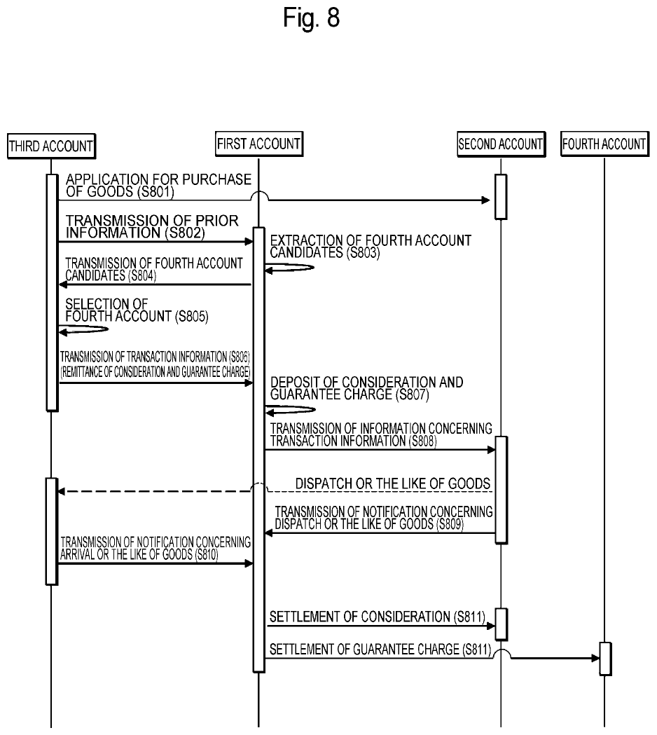

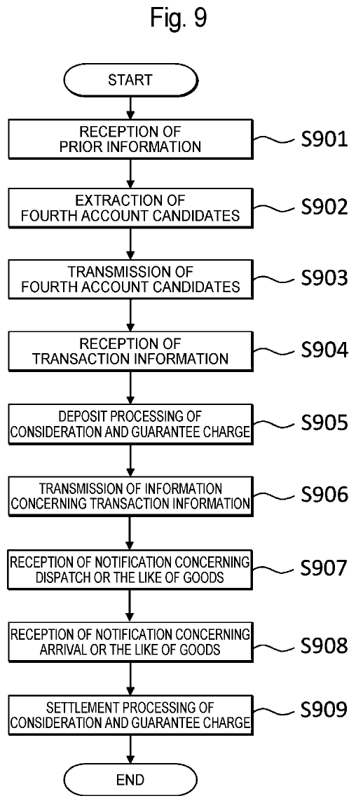

Processing of the information processing device according to the first embodiment is explained with reference to FIGS. 8 and 9. FIG. 8 shows an example of a sequence chart showing processing performed by the communication system 1 in the first embodiment. FIG. 9 shows an example of a flowchart of processing in the contract information processing device 200A in the first embodiment. A processing procedure explained below is only an example. Respective kinds of processing may be changed as long as possible within the scope of the technical idea of the present disclosure. Omission, substitution, and addition of steps are possible as appropriate. Respective kinds of processing performed by the contract information processing device 200A can be executed on the basis of the contract code, that is, according to the smart contract.

### Processing for Determining an Escrow Account and a Guarantee Charge

First, a flow of processing for determining an escrow account and a guarantee charge is explained with reference to FIGS. 8 and 9. First, in step S801, an application for purchase of goods is performed from the purchaser account to the seller account, whereby consensus building to the effect that a transaction is started is made between the seller account and the purchaser account.

In this case, the seller account and the purchaser account can consent to a payment source of a guarantee charge and an amount of the guarantee charge desired by the payment source. The payment source of the guarantee charge may be one of the seller account and the purchaser account or may be both of the seller account and the purchaser account. The desired amount of the guarantee charge may be determined within a range of information concerning a guarantee charge corresponding to credit information of the payment source or the like.

In principle, both of the seller account and the purchaser account have a determination right concerning the payment source of the guarantee charge and the amount of the guarantee charge desired by the payment source. The payment source of the guarantee charge and the amount of the guarantee charge desired by the payment source can be determined by consent of the seller account and the purchaser account. In this case, a consensus building process necessary for reaching the consent can he performed in step S801. Specifically, as an example, there is a method of repeating exchange of notifications in which one or both of the accounts present a payment source and a desire of a guarantee charge and, when the accounts cannot consent to the payment source and the guarantee charge, present a payment source and a desire of a guarantee charge until the accounts can consent to the payment source and the guarantee charge.

As a method of simplifying such exchange, a method in which one account presents, in advance, a condition that can be consented and the other account consents to the condition may be adopted. For example, a method is conceivable in which, simultaneously with presenting goods to be sold, the seller account presents that, as conditions for the sale, the purchaser account bears an entire guarantee charge and the guarantee charge is set to a predetermined amount or more and the purchaser account applies for purchase when the purchaser account can consent to the sales conditions. Instead, simultaneously with the purchase application, the purchaser account may present that, as purchase conditions, the seller account bears an entire guarantee charge and the guarantee charge is set to a predetermined amount or more. When the seller account can consent to the purchase conditions, the seller account may approve the purchase application. Concerning consent to an amount of the guarantee charge, an amount of the guarantee charge may be presented or an escrow operator may be presented instead of the amount of the guarantee charge. Instead of the above, one of the seller account and the purchaser account may determine the payment source of the guarantee charge and the amount of the guarantee charge desired by the payment source by abandoning the determination right.

A form in which the purchaser account pays an entire guarantee charge is explained below. However, the form is not limited to the below.

In step S802, the seller account and/or the purchaser account transmits prior information including the desired amount of the guarantee charge consented as explained above to the blockchain network with the contract account set as a destination. The contract account, which receives the prior information, extracts candidates of the escrow account on the basis of the prior information (S803 and S901 to S902). Examples of this specific method include a method of extracting, from the escrow information DB 332, candidates of the escrow account that can be requested to mediate the desired amount of the guarantee charge. In addition, candidates of the escrow account may be extracted from the escrow information DB 332 considering information concerning a category of goods or services that the escrow user can mediate, information concerning an upper limit and a lower limit of a consideration that can be mediated, and credit information the seller account and the purchaser account that can be mediated.

The contract account performs processing for transmitting, according to necessity, the candidates extracted in this way to the blockchain network with the seller account and/or the purchaser account set as a destination together with credibility of the candidates and/or a guarantee charge necessary for selecting the candidates (S804 and S903). The seller account and/or the purchaser account selects the escrow account out of a plurality of candidates through the consensus building process (S805). Examples of this specific method include a method of repeating exchange of notifications in which one or both of the accounts present a desired escrow account, determine whether consent is possible, and, when the accounts cannot consent to the escrow account, present a desire of an escrow account until the accounts can consent to the escrow account. Instead of the above, one of the seller account and the purchaser account may select an escrow account by abandoning a selection right or only a payment source of a guarantee charge may have a selection right to select an escrow account.

When the consent to the amount of the guarantee charge in step S801 is consent to an escrow operator instead of the amount of the guarantee charge, steps S802 to S805 can be omitted.

By performing the processing explained above, the guarantee charge and the escrow account are determined for an individual transaction.

### Deposit Processing

A flow of despite processing is explained with reference to FIGS. 8 and 9. In steps S806 and S904, the purchaser account transmits transaction information for deposing a consideration and a guarantee charge with the contract account from the purchaser account. The contract account receives the transaction information.

The contract account performs, on the basis of the received transaction information, deposit processing for temporarily keeping a consideration and a guarantee charge (S807 and S905). For example, when a virtual asset is used for payment, the transaction information includes information concerning transfer of the virtual asset from a transfer source to the contract account, the information being information electronically signed by an encryption key (a key for proving ownership of the virtual asset) owned by a user who owns the virtual asset at the transfer source. This information is transmitted on the blockchain network, whereby deposit into the contract account is performed. When an asset other than the virtual asset is used, the transaction information includes, for example, information for enabling the contract account to access an external system (e.g., an account management system of a bank) constructed by a server or the like operated by another operator (a third party) or another business department. An asset of the seller account or the purchaser account managed by the external system is transferred to the contract account using this information, whereby deposit into the contract account is performed. The asset of the seller account or the purchaser account managed by the external system is transferred to an account of the contract account managed by another external system, whereby deposit into the contract account may be performed. However, a deposit method is not limited to the above if processing for depositing the consideration and the guarantee charge into the contract account is performed.

In steps S808 and S906, the contract account transmits, on the basis of the received transaction information, information concerning the transaction information to the seller account. In this case, the transaction-information processing unit 3232 can output, according to a category of goods or services and credit information of the seller account and the purchaser account, a standard date of a dispatch date or an arrival date of the goods or a provision date of the services and include the standard date in the information concerning the transaction information.

For example, when goods such as vegetable and fruit have an expiry date, it is possible to guarantee reliability of a transaction by setting a dispatch date or an arrival date of the goods to an earlier date. Even when credit information of the seller account is low, it is possible to guarantee reliability of a transaction by setting the dispatch date or the arrival date of the goods to an earlier date. Besides, when transactions between the seller account and the purchaser account are performed many times and the transactions between the seller account and the purchaser account are stably performed, the dispatch date or the arrival date of the goods may be set to a later date. Information serving as a standard of a dispatch date or an arrival date of goods or a provision date of services is also used for, when a period of the standard elapses, the progress confirming unit to transmit a notification for confirming a transaction situation to the seller account and the escrow account.

By performing the processing explained above, a consideration and a guarantee charge are deposited into the contract account for an individual transaction.

### Processing Concerning a Completion Notification

In step S809, after the dispatch or the like of the goods, the seller account transmits, to the contract account, a completion notification to the effect that the seller account has performed an act liable to a consideration. The completion notification to the effect that the seller account has performed an act liable to consideration refers to, for example, if goods are liable to a consideration, a notification concerning dispatch or the like of the goods and refers to, for example, if services are liable to a consideration, notification concerning provision or the like of the services. In this case, the progress processing unit 3234 may output, according to a reception date of the notification concerning the dispatch or the like of the goods, a standard date when the purchaser account should report arrival or the like of the goods to the contract account and notify the standard date to the purchaser account together with a dispatch communication of the goods.

After reception of the notification concerning the dispatch or the like of the goods, when a date of the notification is earlier than the dispatch date or the like of the goods set as the standard, the BC-information processing unit. 322 of the contract information processing device 200A can perform processing for improving the credibility of the seller account. For example, when, within a predetermined period, not receiving the notification concerning the dispatch or the like of the goods from the seller account even if the dispatch date or the like of the goods set as the standard elapses, the BC-information processing unit 322 may perform refund processing for transferring a consideration and a guarantee charge from the contract account to the purchaser account. Instead of the refund processing, the BC-information processing unit 322 may transmit a notification for confirming a state of the transaction to the escrow account. In this case, the BC-information processing unit 322 of the contract information processing device 200A can perform processing for reducing the credibility of the seller account.

### Processing Concerning a Result Notification

In step S810, the purchaser account, which receives the goods, transmits a result notification to the effect that goods or services are received to the contract account. The result notification to the effect that goods or services are received refers to, for example, if goods are liable to a consideration, a notification concerning arrival or the like of the goods and, if services are liable to a consideration, a notification concerning reception or the like of provision of the services.

After the reception of the notification concerning arrival or the like of the goods, when a date of the notification is earlier than a report date or the like of goods arrival set as a standard, the BC-information processing unit 322 of the contract information processing device 200A may perform processing for improving the credibility of the purchaser account. When not receiving the result notification from the purchaser account within a predetermined period, the BC-information processing unit 322 may transmit, to the purchaser account, a notification for urging the purchaser account to transmit the result notification and may transmit, to the escrow account, a notification for confirming a state of the transaction related to the transaction information.

When receiving, from the purchaser account, instead of the result notification, a notification to the effect that there is a defect in the transaction related to the transaction information, the progress processing unit 3234 of the contract information processing device 200A may transmit, to the purchaser account, a notification for requesting the escrow account to prove that there is the defect and may receive a proof result of the defect from the escrow account.

The escrow account sorts out a situation of the transaction. When a defect is not found in the transaction on the basis of the transaction information, the escrow account transmits indication to the effect that normal settlement processing is performed to the contract account. When a defect is found in the transaction, the escrow account transmits indication to the effect that refund or goods return processing or price reduction processing is performed to the escrow account. A determination process concerning a defect of the transaction performed by the escrow account is advanced under consent of the seller account and the purchaser account. Exchange of notifications among the accounts and proving related to presence or absence of a defect can be performed via the blockchain network. Consequently, a transaction history is saved in the BC information DB 331.

### Settlement Processing

In step S811, when receiving, from the purchaser account that deposits the consideration, the result notification to the effect that goods or services are received, the contract account performs settlement processing for transferring the consideration from the contract account to the seller account and transferring the guarantee charge from the contract account to the escrow account.

When not receiving the notification of the dispatch or the like of the goods from the seller account for a fixed period, since exchange of the goods or the like is not performed, the contract account can perform settlement processing for returning the deposited consideration and the deposited guarantee charge from the contract account to the purchaser account. On the other hand, when a defect occurs in the transaction after the notification of the dispatch or the like of the goods is received and when mediation by the escrow account is performed, the escrow account can perform settlement processing for transferring the guarantee charge to the escrow account irrespective of success or failure of the transaction. A defect occurs in the transaction after the notification of the dispatch or the like of the goods is received, for example, when a notification concerning arrival of the goods is not received from the purchaser account for a fixed period or more or when a notification to the effect that there is a defect in the arrived goods is received from the purchaser account.

Consequently, in addition to escrow performed for a goods transaction performed by depositing a consideration of goods into the contract account and, when a predetermined condition is satisfied, paying the deposited consideration to the seller account, escrow for a mediation job can also be performed by depositing a guarantee charge into the contract account as well and, when a predetermined condition is satisfied, paying the deposited guarantee charge to the escrow account. Therefore, it is possible to guarantee security of the transaction between the seller account and the purchaser account and guarantee the reliability of the mediation job of the escrow account.

### FIRST EXAMPLE

A first example of the first embodiment is explained. The first example of the first embodiment is an example in which, in processing for determining an escrow account and a guarantee charge, both of the seller account and the purchaser account consent to payment of guarantee charges at predetermined rates and, in deposit processing, the seller account and/or the purchaser account transmits transaction information for depositing the guarantee charge into the contract account from both of the seller account and the purchaser account, and the contract account receives the transaction information.

In the following explanation, the same functional components as the functional components in the first embodiment are denoted by the same reference numerals and signs. Explanation of the functional components is omitted. Explanation is omitted concerning the same action and effects as the action and effects in the first embodiment as well. Differences from the first embodiment are mainly explained below.

In the first example, both of the seller account and the purchaser account pay the guarantee charges at the predetermined rates. If a defect occurs in a transaction after a notification of dispatch or the like of goods is received and if mediation by the escrow account is performed, the guarantee charges deposited by the seller account and the purchaser account are paid to the escrow account irrespective of success or failure of the transaction.

### EFFECTS OF THE FIRST EXAMPLE

When one of the seller account and the purchaser account deposits a guarantee charge, the other is not charged a guarantee charge even if there is a defect in the transaction. Compared with such a case, according to the first example explained above, by causing both of the seller account and the purchaser account to deposit the guarantee charges, it is possible to motivate to the seller account and the purchaser account not to cause a defect in the transaction. Besides, even if a defect occurs in the transaction, it is expected that the seller account and the purchaser account are cooperative with the mediation of the escrow account to prevent disadvantages to the seller account and the purchaser account. Consequently, it is possible to realize a more sincere transaction system.

### FUNCTIONAL CONFIGURATION OF THE FIRST EXAMPLE

A functional configuration of the information processing devices 200A to 200D in the first example can be set the same as the functional configuration in the first embodiment.

### OPERATION PROCESSING IN THE FIRST EXAMPLE

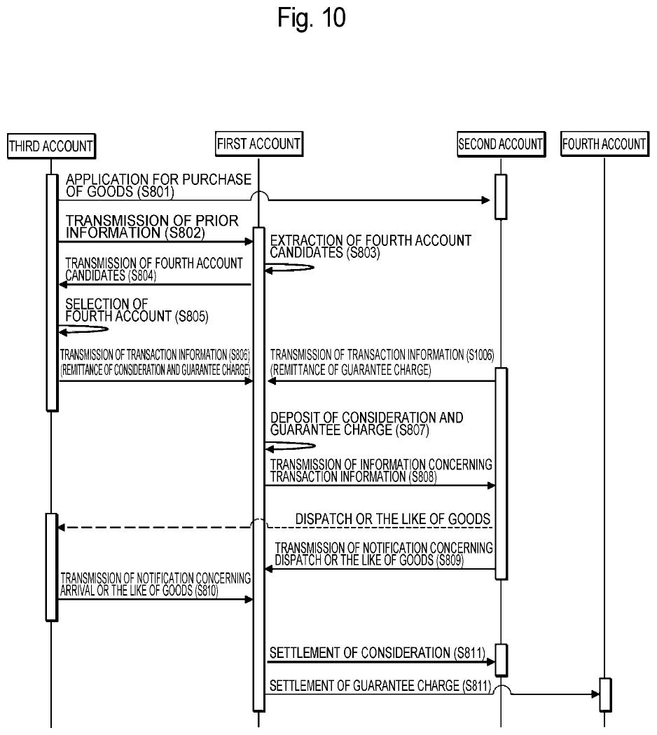

Processing of the information processing device according to the first example is explained with reference to FIG. 10. FIG. 10 shows an example of a sequence chart showing processing performed by the communication system 1 in the first example. A processing procedure explained below is only an example. Respective kinds of processing may be changed as long as possible within the scope of the technical idea of the present disclosure. Omission, substitution, and addition of steps are possible as appropriate.

Operation processing in the first example can be set the same as the operation processing in the first embodiment except that the contract account receives the transaction information for depositing, with the contract account, the guarantee charges from both of the seller account and the purchaser account transmitted by the seller account and/or the purchaser account in steps S806 and S1006.

### SECOND EXAMPLE

A second example of the first embodiment is explained. The second example of the first embodiment is an example in which, in processing for determining an escrow account and a guarantee charge, the contract account transmits information concerning prior information to extracted candidates of the escrow account and the escrow user selects a transaction mediated by the escrow user.

In the following explanation, the same functional components as the functional components in the first embodiment are denoted by the same reference numerals and signs. Explanation of the functional components is omitted. Explanation is omitted concerning the same action and effects as the action and effects in the first embodiment as well. Differences from the first embodiment are mainly explained below.

### EFFECTS OF THE SECOND EXAMPLE

According to the second example explained above, since the escrow user selects a transaction mediated by the escrow user, the escrow user can more actively expand a mediation business. For example, since the escrow user selects a transaction mediated by the escrow user, the escrow user is capable of specializing in mediation of a product category at which the escrow user is skillful. The escrow user can accumulate know how of a mediation job. Such specialization of the escrow user can contribute to further smoothing of a transaction between the seller user and the purchaser user.

### FUNCTIONAL CONFIGURATION OF THE SECOND EXAMPLE

A functional configuration of the information processing devices 200A to 200D in the second example can be set the same as the functional configuration in the first embodiment.

### OPERATION PROCESSING IN THE SECOND EXAMPLE

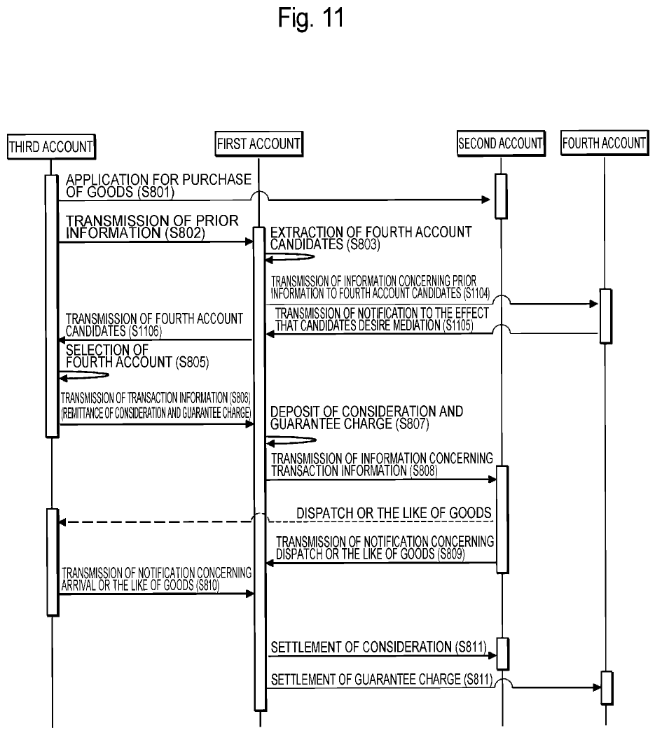

Processing of the information processing device according to the second example is explained with reference to FIG. 11. FIG. 11 shows an example of a sequence chart showing processing performed by the communication system 1 in the second example. A processing procedure explained below is only an example. Respective kinds of processing may be changed as long as possible within the scope of the technical idea of the present disclosure. Omission, substitution, and addition of steps are possible as appropriate.

Operation processing in the second example can be set the same as the operation processing in the first embodiment except that, in step S1104, processing for transmitting information concerning prior information to extracted candidates of the escrow account is performed, processing for receiving, from the candidates, notifications to the effect that the candidates desire to mediate a transaction is performed, and a list of the candidates desiring to perform mediation is transmitted to the seller account and/or the purchaser account.

The mediation information DB of the escrow information processing device 200D may include a management table that stores prior information received from the contract account. In this case, the escrow user can select the candidates desiring to perform mediation out of the prior information stored in the management table.

As explained above, the present disclosure is not limited to the embodiment and the examples explained above. Various modifications are possible within a range not departing from the gist of the present disclosure. That is, the embodiment is only a simple illustration in all aspects and is not limitedly interpreted. For example, a common key may be used instead of the secret key. Communication means of the blockchain network does not always need to conform to the P2P communication protocol if the blockchain network is a network in which information concerning the blockchain is distributed and shared among nodes.

The respective kinds of processing performed by the contract information processing device 200A is not limited to processing executed on the basis of the contract code, that is, according to the smart contract. An information processing device owned by a user participating in the blockchain network may perform the same processing on behalf of the contract information processing device 200A. In this case, the information processing device that performs the processing on behalf of the contract information processing device 200A and/or a user account associated with the information processing device can be selected out of the seller account, the purchaser account, and the escrow account on the basis of credit information based on a transaction history or the like in the past, for example. In this case, a renumeration corresponding to a guarantee charge or a consideration may be paid to the user who executes the same processing as the processing executed by the smart contract.

### Cross-Reference to Related Application

This application is based upon Japanese Patent Application No. 2018-178241 filed on Sep. 25, 2018, the contents of which are incorporated herein.

### REFERENCE SIGNS LIST

1 communication system, 4 escrow, 110 server, 110A server, 110B server, 120 terminal, 120A terminal, 120B terminal, 1200 terminal, 120X terminal, 130 network, 200 information processing device, 200A first information processing device, 2008 second information processing device, 200C third information processing device, 200D fourth information processing device, 201 processor, 202 memory, 203 storage, 204 input and output interface (input and output I/F), 205 communication interface (communication I/F), 311 input and output I/F, 312 communication I/F, 320 control unit, 321 receiving unit, 322 information processing unit, 323 contract processing unit, 3231 prior-information processing unit, 3232 transaction-information processing unit, 3233 settlement processing unit, 3234 progress processing unit, 324 transmitting unit, 330 storing unit, 331 BC information DB, 332 escrow information DB, 333 program, 511 input and output I/F, 512 communication I/F, 520 control unit, 521 selling unit, 522 receiving unit, 523 transmitting unit, 530 storing unit, 531 goods information DB, 532 BC information DB, 533 program, 611 input and output I/F, 612 communication I/F, 620 control unit, 621 purchasing unit, 622 receiving unit, 623 transmitting unit, 630 storing unit, 631 purchase information DB, 632 BC information DB, 633 program, 711 input and output I/F, 712 communication I/F, 720 control unit, 721 mediation-condition registering unit, 722 receiving unit, 723 transmitting unit, 730 storing unit, 731 mediation information DB,

What is claimed is:

1. A computer-readable non-transitory storage medium storing a program for causing one or a plurality of processors included in an information processing device to execute:
deposit processing for, when receiving transaction information for depositing a consideration of goods or services and a guarantee charge into a first account, transmitting, on the basis of the received transaction information, information concerning the transaction information to a second account that receives the consideration; and
settlement processing for, after performing the deposit processing, when receiving, from a third account which deposits the consideration, a result notification to the effect that the goods or the services are received, transferring the consideration from the first account to the second account and transferring the guarantee charge from the first account to a fourth account.

2. The computer-readable non-transitory storage medium storing the program according to claim 1, wherein the transaction information includes information concerning the fourth account selected out of a plurality of candidates.

3. The computer-readable non-transitory storage medium storing the program according to claim 1, further causing the one or the plurality of processors to execute, before performing the deposit processing, processing for, when receiving prior information concerning a transaction, extracting a candidate of the fourth account on the basis of the received prior information and transmitting the extracted candidate of the fourth account to the third account and/or the second account.

4. The computer-readable non-transitory storage medium storing the program according to claim 3, wherein, in the processing for transmitting the extracted candidate of the fourth account, information concerning credibility of the candidate and/or a guarantee charge necessary for selecting the candidate is transmitted together with the candidate of the fourth account.

5. The computer-readable non-transitory storage medium storing the program according to claim 1, further causing the one or the plurality of processors to execute, before the deposit processing, processing for, when receiving prior information concerning a transaction, extracting a candidate of the fourth account on the basis of the received prior information and transmitting information concerning the prior information to an account of the extracted candidate.

6. The computer-readable non-transitory storage medium storing the program according to claim 1, further causing the one or the plurality of processors to execute refund processing for, when not receiving, from the second account, within a predetermined period after the deposit processing, a completion notification to the effect that an act liable to the consideration is performed, transferring the consideration and the guarantee charge from the first account to the third account.

7. The computer-readable non-transitory storage medium storing the program according to claim 1, further causing the one or the plurality of processors to execute processing for, when not receiving, from the third account, the result notification within a predetermined period after receiving, from the second account, a completion notification to the effect that an act liable to the consideration is performed, transmitting, to the third account, a notification for urging the third account to transmit the result notification and transmitting, to the fourth account, a notification for confirming a state of a transaction related to the transaction information.

8. The computer-readable non-transitory storage medium storing the program according to claim 1, further causing the one or the plurality of processors to execute:
processing for, after receiving, from the second account, a completion notification to the effect that an act liable to the consideration is performed, when receiving, from the third account, instead of the result notification, a notification to the effect that there is a defect in a transaction related to the transaction information, transmitting, to the fourth account, a notification for requesting the fourth account to prove that there is the defect in the third account; and
processing for receiving a proving result of the defect from the fourth account.

9. The computer-readable non-transitory storage medium storing the program according to claim 1, wherein the program causes the one or the plurality of processors to execute the deposit processing and the settlement processing according to a smart contract.

10. An information processing apparatus comprising one or a plurality of processors,
the one or the plurality of processors executing:
processing for receiving transaction information to the effect that a consideration of goods or services and a guarantee charge are deposited into a first account and a result notification to the effect that the goods or the services are received;
processing for transmitting, on the basis of the received transaction information, information concerning the transaction information to a second account that receives the consideration; and
processing for, when receiving, from a third account which deposits the consideration, a result notification to the effect that the goods or the services are received, transferring the consideration from the first account to the second account and transferring the guarantee charge from the first account to a fourth account.

11. An information processing method, comprising:
by one or a plurality of processors included in an information processing device,
deposit processing for, when receiving transaction information for depositing a consideration of goods or services and a guarantee charge into a first account, transmitting, on the basis of the received transaction information, information concerning the transaction information to a second account that receives the consideration; and
settlement processing for, after performing the deposit processing, when receiving, from a third account which deposits the consideration, a result notification to the effect that the goods or the services are received, transferring the consideration from the first account to the second account and transferring the guarantee charge from the first account to a fourth account.

12. An information processing method, in an information processing system including a first information processing device associated with a first account, second information processing device associated with a second account, a third information processing device associated with a third account, and a fourth information processing device associated with a fourth account,
one or a plurality of processors included in the first information processing device executing:
deposit processing for, when receiving transaction information for depositing a consideration of goods or services and a guarantee charge into the first account, transmitting, on the basis of the received transaction information, information concerning the transaction information to the second account that receives the consideration; and
settlement processing for, after performing the deposit processing, when receiving, from the third account which deposits the consideration, a result notification to the effect that the goods or the services are received, transferring the consideration from the first account to the second account and transferring the guarantee charge from the first account to the fourth account, the method comprising:
by one or a plurality of processors of the second information processing device,
processing for receiving information concerning the transaction information from the first account; and
processing for receiving transaction information to the effect that the consideration is transferred from the first account to the second account.

13. An information processing method, in an information processing system including a first information processing device associated with a first account, a second information processing device associated with a second account, a third information processing device associated with a third account, and a fourth information processing device associated with a fourth account,
one or a plurality of processors included in the first information processing device executing:
deposit processing for, when receiving transaction information for depositing a consideration of goods or services and a guarantee charge into the first account, transmitting, on the basis of the received transaction information, information concerning the transaction information to the second account that receives the consideration; and
settlement processing for, after performing the deposit processing, when receiving, from the third account which deposits the consideration, a result notification to the effect that the goods or the services are received, transferring the consideration from the first account to the second account and transferring the guarantee charge from the first account to the fourth account, the method comprising:
by one or a plurality of processors included in the third information processing device,
processing for transmitting, to the first account, transaction information for depositing the consideration into the first account; and
processing for transmitting the result notification to the first account.
